(19) United States
(12) Patent Application Publication
(10) Pub. No.: US 2024/0126537 A1
(43) Pub. Date: Apr. 18, 2024

(54) SOFTWARE APPLICATION MANAGEMENT IN HETEROGENEOUS MANAGED NETWORKS

(71) Applicant: Ivanti, Inc., South Jordan, UT (US)

(72) Inventors: Brent Miller, Minnetonka, MN (US); Todd A. Schell, San Antonio, TX (US); John Meisner, New Brighton, MN (US); Amanda Schultz, New Brighton, MN (US); Mitch Berg, New Brighton, MN (US)

(73) Assignee: Ivanti, Inc., South Jordan, UT (US)

(21) Appl. No.: 18/489,797

(22) Filed: Oct. 18, 2023

Related U.S. Application Data
(60) Provisional application No. 63/379,977, filed on Oct. 18, 2022.

(51) Int. Cl. G06F 8/65

(52) U.S. Cl. CPC G06F 8/65

(57) ABSTRACT

An embodiment includes a method of computer software update in a managed network that includes endpoints having heterogenous operating systems. The method includes receiving a first update configured modify a first application on a first endpoint implementing a first non-Linux-based operating system (OS) and first metadata associated therewith. The method includes generating a first update package based on the first metadata and distributing the first update and the first update package to the first endpoint. The method includes accessing a product update list identifying a second application in an unpatched state on the second endpoint implementing a Linux-based OS and repository information of a repository device. Based on the repository information, the method includes accessing the second update and second metadata associated therewith. The method includes generating a second update package and distributing it and the second update such that the second endpoint locally implements the second update.

### CROSS-REFERENCE TO RELATED APPLICATION

This application claims priority to and the benefit of U.S. Provisional Application No. 63/379,977, filed Oct. 18, 2022, which is incorporated herein by reference in its entirety.

### FIELD

The present disclosure generally relates to software application update management. Some embodiments are directed to systems and methods implemented to manage software application updates in heterogeneous, managed networks including endpoints having multiple, different operating systems.

### BACKGROUND

In computer network environments, software vendors provide product updates that are distributed and implemented to repair or improve software applications. The product updates may include version changes or patches, which generally include software code and instructions along with some metadata that describe characteristics of the product update.

In managed networks of computing devices, entities may employ a patch management service that vets the product updates and coordinates distribution of the product updates among appropriate managed devices. Additionally, the patch management service may generate a package. The package may include scripts, commands, application programming interface (API), etc. that may be implemented at the computing devices to locally implement the product update.

In Windows®-based environments and iOS®-based environments, patch management and product update distribution are similar from one software application to the next software application. However, in Linux-based devices and environments that incorporate the Linux-based systems (collectively, Linux systems) patch management and product update distribution vary significantly between vendors and between software applications.

Variation in the patch management of the Linux systems results in failures of patch manage services. For instance, patch management services directed to Linux systems often leave computing devices unpatched, fail to provide administrators and policies with sufficient metadata regarding product updates for proper evaluation, or fail to properly automate patch operations in managed networks including Linux systems and non-Linux systems.

Accordingly, a need exists in patch management technological field to improve product update evaluation and distribution in managed networks. This need exists especially in managed networks including Linux systems and non-Linux systems, which is referred to as heterogenous-operating system (OS) managed networks.

The subject matter claimed in the present disclosure is not limited to embodiments that solve any disadvantages or that operate only in environments such as those described above. Rather, this background is only provided to illustrate one example technology area where some embodiments described in the present disclosure may be practiced.

### SUMMARY

According to an aspect of the invention, an embodiment includes a method of computer software update in a managed network that includes endpoints having heterogenous operating systems. The method may include receiving from a second vendor device a first update configured modify a first application on a first endpoint and first metadata associated with the first update. The first endpoint may be included in a manage network and implements a first operating system (OS), and the first application is configured to operate on the first OS. The first OS may include a non-Linux-based OS and the second OS may include a Linux-based OS. The method may include generating a first update package based on the first metadata. The first update package may include a command and data sufficient to implement the first update on the first endpoint. The method may include distributing the first update and the first update package to the first endpoint such that the first endpoint implements the first update according to the first update package to modify the first application. The method may include accessing, from an agent of a second endpoint, a product update list. The product update list identifies a second application on the second endpoint that is in an unpatched state and repository information of a repository device with which the second endpoint communicates to access a second update associated with the second application. The second endpoint may be included in the manage network and implements a second OS. The second application may be configured to operate on the second OS. Based on the repository information, the method may include accessing, from a repository device, the second update and second metadata associated with the second update, wherein the repository device is communicatively coupled to a first vendor device that operates outside the managed network. The method may include generating a second update package based on the second metadata. The second update package may include a command and data sufficient to implement the second update on the second endpoint. The method may include distributing the second update and the second update package. The distribution may be configured such that the second endpoint locally implements the second update according to the second update package to modify the second application.

A further aspect of an embodiment may include non-transitory computer-readable medium having encoded therein programming code executable by one or more processors to perform or control performance of one or more of the operations of the methods described above.

An additional aspect of an embodiment may include compute device comprising one or more processors and a non-transitory computer-readable medium having encoded therein programming code executable by one or more processors to perform or control performance of one or more of the operations of the methods described above.

The object and advantages of the embodiments will be realized and achieved at least by the elements, features, and combinations particularly pointed out in the claims. It is to be understood that both the foregoing general description and the following detailed description are exemplary and explanatory and are not restrictive of the invention, as claimed.

### BRIEF DESCRIPTION OF THE DRAWINGS

Example embodiments will be described and explained with additional specificity and detail through the accompanying drawings in which:

FIG. 1 is a diagram of an example operating environment in which some embodiments of the present disclosure may be implemented;

FIGS. 2A-2C depict a heterogenous-operating system product update process that may be implemented in the operating environment of FIG. 1;

FIG. 3 illustrates an example computer system configured for computer software update in a managed network that includes endpoints having heterogenous operating systems;

FIGS. 4A and 4B are a flow chart of an example method of computer software update in a managed network that includes endpoints having heterogenous operating systems;

FIG. 5 is a flow chart of another example method of computer software update in a managed network that includes endpoints having heterogenous operating systems; and

FIGS. 6A and 6B depict a block diagram of an example user interface that may be implemented in the heterogenous-operating system product update process of FIG. 2, all according to at least one embodiment of the present disclosure.

### DETAILED DESCRIPTION

Software applications or product updates of endpoints may be managed. For instance, patch management services applied to endpoints in managed networks may evaluate product updates and coordinate distribution of the product updates to an appropriate subset of the managed endpoints.

In some managed networks, a first portion of the endpoints may have a Linux-based operating system (OS) and a second portion of the endpoints may have a non-Linux-based OS. In the present disclosure, these types of managed networks are referred to as heterogenous-OS managed networks or heterogenous-OS networks. In heterogenous-OS networks, existing patch management services are ineffective at evaluating and distributing product updates directed to the Linux-based systems. For instance, the way in which product updates are made available by vendors for different Linux-based software applications vary considerably, an amount and content of metadata associated with the Linux-based software applications vary considerably, and evaluation of the product updates by third parties are inconsistent and rare relative to non-Linux-based software applications.

Accordingly, embodiments of the present disclosure are directed to patch management services in heterogenous-OS managed networks. For example, some embodiments are configured to implement an agent on managed endpoints. The agent is configured to access data and information related to software applications operating on the managed endpoints. Additionally, the agent is configured to communicate an inquiry to repository devices with which the software application communicates to access the product updates. The agent then communicates a product update list that indicates which software applications are unpatched at the managed endpoint along with repository information where the product update and associated metadata is available. The product update list is received by an update device configured to coordinate the patch management service. The update device may evaluate the available metadata against a policy. The policy may define characteristics of the product update that triggers an automated patch operation.

Use of the product update list enables the update device to identify unpatched applications. Additionally, the repository information enables the update device to access available metadata and process the available metadata. In some circumstances in which the metadata available at the repository device is insufficient for evaluation, the update device may access missing metadata at a public or outside source such as a common vulnerabilities and exposure (CVE) host site. After the metadata is sufficient for evaluation, a package may be generated for the product update, which may be distributed to the managed endpoint.

Additionally or alternatively, in some circumstances in which the metadata available at the repository device is insufficient for evaluation, the update device may default to initiate a distribution of the software update. In these and other circumstances, the update device may treat the insufficient metadata as if the software update is critical. The update device may accordingly ensure the software update is distributed instead of allowing a potential vulnerability to persist on endpoints.

In some heterogenous-OS networks, non-Linux endpoints may be managed according to conventional operations. An example of a conventional patch management service includes Ivanti® Security Controls and Ivanti Neurons® for Patch Management. Systems and methods described in the present disclosure may be implemented with the conventional operations to effectively manage the Linux-based endpoints in heterogenous-OS networks.

These and other embodiments are described with reference to the appended Figures in which like item number indicates like function and structure unless described otherwise. The configurations of the present systems and methods, as generally described and illustrated in the Figures herein, may be arranged and designed in different configurations. Thus, the following detailed description of the Figures, is not intended to limit the scope of the systems and methods, as claimed, but is merely representative of example configurations of the systems and methods.

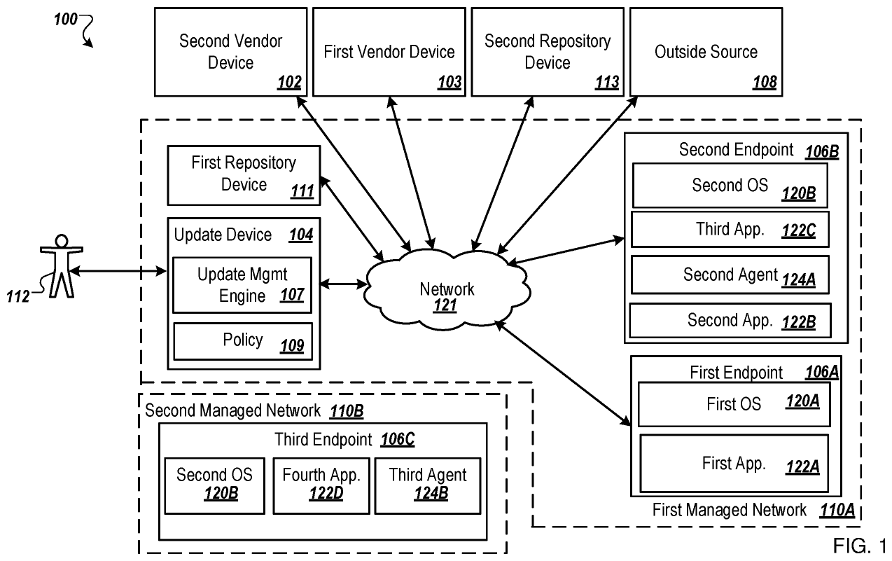

FIG. 1 is a block diagram of an example operating environment 100 in which some embodiments of the present disclosure may be implemented. The operating environment 100 includes managed networks 110A and 110B (generally, managed network 110 or managed networks 110). The managed networks 110 include endpoints 106A-106C (generally, endpoint 106 or endpoints 106) that are managed at least partially by an update device 104. For example, the update device 104 may include an update management engine 107 that implements a policy 109 that initiates distribution and implementation of product updates at the endpoints 106.

In the embodiment of FIG. 1, the endpoints 106 may implement an operating system 120A and 120B (generally, OS 120 or OS's 120). The OS's 120 support computing functions at the endpoints 120 such as execution of software applications 122A-122D (generally, application 122 or applications 122), control of peripherals, coordinating computing tasks and operations, and the like. The endpoints 106 of the managed networks 110 have heterogenous or different OS's. As used in the present disclosure “heterogenous-OS” indicates that a first portion of the endpoints 106 include a Linux-based OS and a second portion of the endpoints 106 include a non-Linux-based OS. For instance, the endpoints 106 of a first managed network 110A include a first endpoint 106A that operates a first OS 120A, which may be a non-Linux-based OS and a second endpoint 106B that operates a second OS 120B, which may be a Linux-based OS. In some embodiments, the first portion may be much smaller (e.g., 1/10, 1/100/1/1000, etc.) than the second portion.

In the managed networks 110 having heterogenous OS's, it is difficult to coordinate and effectively implement management operations such as evaluation and distribution of updates associated with the applications 122. For instance, a majority of endpoints (e.g., 106) operate a non-Linux-based OS such as Windows®, macOS® (also referred to as OS X), Chrome OS®, and the like. Accordingly, conventional update devices may be configured to distribute updates in non-Linux-based systems. For instance, a second vendor device 102 may be configured to communicate or make available a first update and associated metadata to the update device 104 for a first application 122A. The update device 104 may evaluate the first update and distribute the first update and an update package associated with the first update to a first endpoint 106A such that the first update is locally implemented.

In contrast, in Linux-based systems (e.g., a second endpoint 106B and a third endpoint 106C) differ significantly from one Linux-based OS to another. Additionally, an administrator 112 may be unfamiliar with update operations related to the Linux-based OS's. Moreover, because of the prevalence of non-Linux-based OS endpoints 106, vendors actively support and direct updates related to the applications 122 configured for operation on the non-Linux-based OS.

Some embodiments of the present disclosure are implemented to standardize update operations related to Linux-based systems. For example, these embodiments enable access to metadata associated with product updates, its sufficiency for evaluation, and distribution according to the policy 109.

The operating environment 100 includes a first vendor device 103, a second vendor device 102, an outside source 108, the endpoints 106, the first repository device 111, and the update device 104, which are configured to communicate data and information via a network 121. Each of these components are introduced in the following paragraphs.

The network 121 may include any communication network configured for communication of signals between the components (e.g., 104 and 106) of the operating environment 100. The network 121 may be wired or wireless. The network 121 may have configurations including a star configuration, a token ring configuration, or another suitable configuration. Furthermore, the network 121 may include a local area network (LAN), a wide area network (WAN) (e.g., the Internet), and/or other interconnected data paths across which multiple devices may communicate. In some embodiments, the network 121 may include a peer-to-peer network. The network 121 may also be coupled to or include portions of a telecommunications network that may enable communication of data in a variety of different communication protocols.

In some embodiments, the network 121 includes or is configured to include a BLUETOOTH® communication network, a Z-Wave® communication network, an Insteon® communication network, an EnOcean® communication network, a Wi-Fi communication network, a ZigBee communication network, a representative state transfer application protocol interface (REST API) communication network, an extensible messaging and presence protocol (XMPP) communication network, a cellular communications network, any similar communication networks, or any combination thereof for sending and receiving data. The data communicated in the network 121 may include data communicated via short messaging service (SMS), multimedia messaging service (MMS), hypertext transfer protocol (HTTP), direct data connection, wireless application protocol (WAP), or any other protocol that may be implemented in the components of the operating environment 100.

The operating environment 100 includes the first vendor device 103 and the second vendor device 102 (collectively, vendor devices 104/102). The vendor devices 104/102 include hardware-based computing systems that are configured to communicate with other components of the operating environment 100 via the network 121.

The first vendor device 103 may be configured to communicate updates and associated metadata to the first repository device 111. The updates and the associated metadata may be accessible at the first repository device 111 by one or more of the endpoints 106.

The first vendor device 103 may be associated with a first vendor that distributes or develops one or more of the applications 122. For instance, the first vendor may develop the second application 122B, the third application 122C, and the fourth application 122D in the embodiment of FIG. 1. The second application 122B, the third application 122C, and the fourth application 122D may be configured to operate on the endpoints 106 operating the second OS 120B, which may be a Linux-based OS. Accordingly, the updates and the associated metadata communicated to the first repository device 111 may have limited metadata and information related to the updates. The second vendor device 102 may be configured to communicate updates and associated metadata to the update device 104 instead of the first repository device 111. The updates and the associated metadata may be accessible by the update device 104. The updates and the associated metadata may be analyzed and distributed to the endpoints 106 in accordance with the policy 109.

The second vendor device 102 may be associated with a second vendor that distributes or develops one or more of the applications 122. For instance, the second vendor may develop the first application 122A in the embodiment of FIG. 1. The first application 122A may be configured to operate on the endpoints 106 operating the first OS 120A, which may be a non-Linux-based OS.

The vendor devices 104/102 may operate outside the managed networks 110. In these and other embodiments, the vendor devices 104/102 may be communicatively coupled to the first repository device 111 or the update device 104 via the network 121.

The outside source 108 includes a hardware-based computing system that is configured communicate with other components of the operating environment 100 via the network 121. The outside source 108 may include any computing system that stores or makes available outside metadata of product updates distributed by the update device 104. In general, the outside metadata indicates that a vendor of one of the applications 122 had not generated or made available to the update device 104. In some embodiments, the outside source 108 may include a source of metadata that is outside the managed networks 110. In some embodiments, the outside source 108 may be a component of a cloud management system that includes the update device 104. Some examples, of the outside source 108 may include a public source such as a common vulnerabilities and exposures (CVE) host site or a vulnerabilities management and prioritization site. An example of the vulnerabilities management and prioritization site may include Ivanti® RiskSense®.

The outside metadata may include any value for a characteristic of a product update. For instance, the characteristics may include a risk rating, a patch name, a security rating, an affected system, a patch type, a patch source, a vulnerability severity. The values for these characteristics may include “a high risk rating,” a “critical risk rating” a “low CVSS rating” a “CVSS score (e.g., 0.1-10.0)”, a CVE number, etc.

The operating environment 100 includes a first managed network 110A and a second managed network 110B. The managed networks 110 are implemented to enable management of the endpoints 106 at least partially by the update device 104. To implement the managed networks 110, the endpoints 106 may be enrolled. After the endpoints 106 are enrolled, ongoing management of the endpoints 106 may be implemented by the update device 104. The ongoing management may include overseeing and dictating at least a part of the operations at the endpoints 106 as described in the present disclosure. The managed networks 110 may be associated with an enterprise, a portion of an enterprise, a government entity, or another entity or set of devices.

In some embodiments, the first managed network 110A is associated with a first entity and the second managed network 110B is associated with a second entity, which is different from the first entity. In these and other embodiments, the update device 104 may communicate with the agents 124 deployed on the endpoints 106 on two or more managed endpoints 106. The update device 104 may implement one or more automated patch operations in multiple managed networks 110.

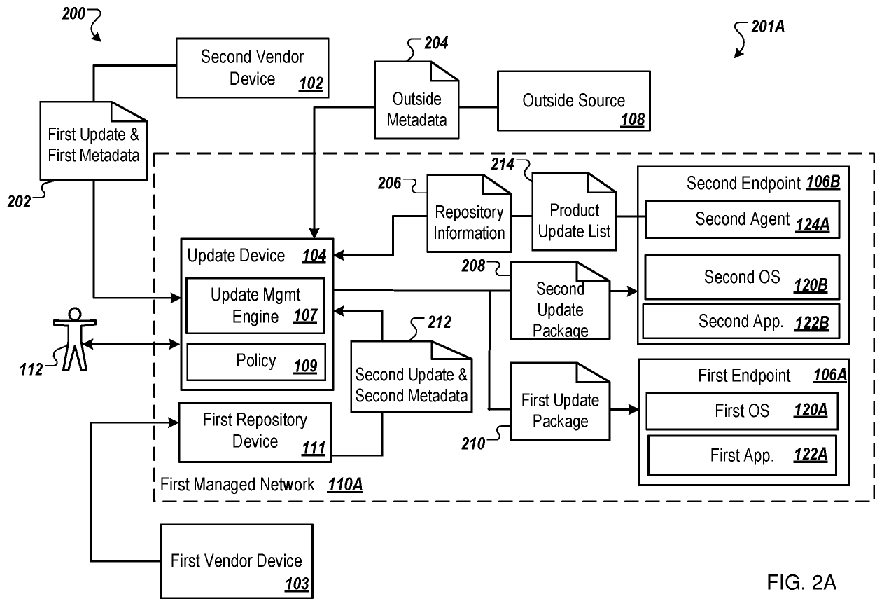

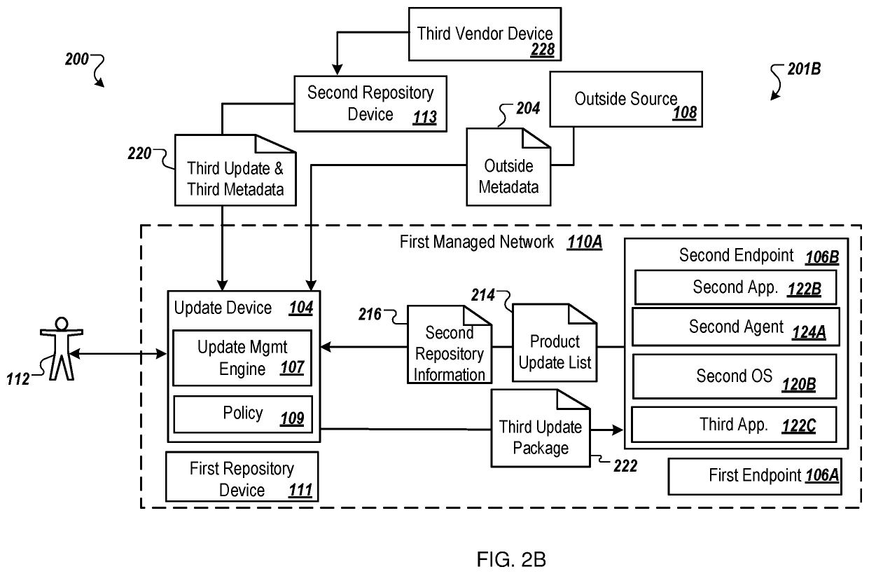

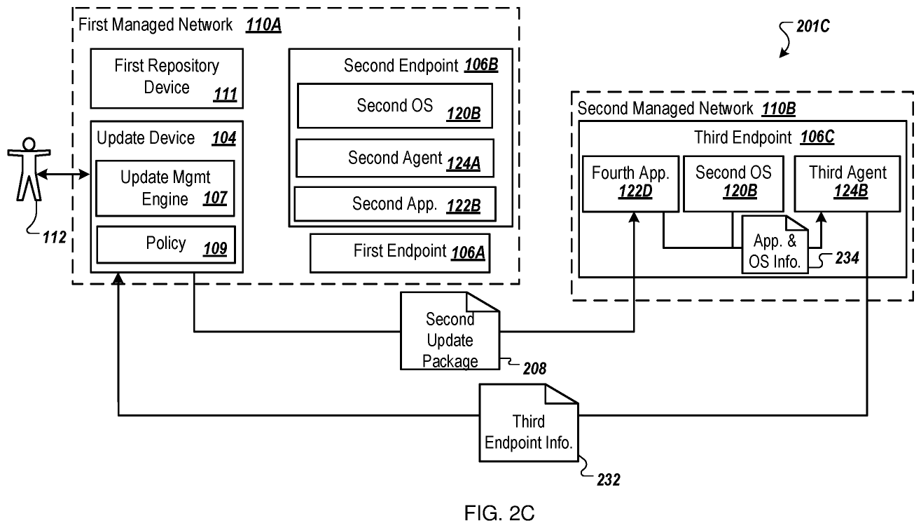

The operating environment 100 includes a first repository device 111 and a second repository device 113 (collectively, repository devices 111/113). The first repository device 111 is communicatively coupled to the first vendor device 103 and the second repository device 113 is communicatively coupled to another vendor device (third vendor device 228 of FIG. 2B). Additionally, the first repository device 111 is associated with the second application 122B and/or the fourth application 122D. The second repository device 113 is associated with the third application 122C.

The repository devices 111/113 store product updates and/or metadata associated with the product updates. In some embodiments, the product updates and/or the metadata may be copied from the vendor devices 104/102. Accordingly, the information and data stored on the repository devices 111/113 may be substantially identical to the update information and data available at the vendor devices 104/102.

The repository devices 111/113 may receive inquiries from the agents 124. For instance, the inquiries may request product updates and associated metadata related to one or more of the applications 122. The inquiry may identify what metadata is available, values associated with the available metadata, whether there is an outstanding product update for the application 122, other information, or combinations thereof.

The repository devices 111/113 may be an entity-specific. For instance, a specific vendor may be specifically associated with one of the repository devices 111/113. Accordingly the associated repository device 111/113 may be an intra-network source of product updates and associated metadata for the vendor. Additionally or alternatively, the administrator 112 may develop one of the repository devices 111/113 to specifically address product updates for one or more of the applications 122. The administrator 112 may pull product updates and metadata and store them at the repository devices 111/113.

The repository devices 111/113 may be accessible by the update device 104. For instance, the agents 124 may provide repository information, which may include network locations of the repository devices 111/113. The repository information may enable the update device to access data and information such as the product updates and metadata from the repository devices 111/113. In some embodiments, the repository devices 111/113 may be included in one of the managed networks 110. Accordingly, the information and data on the repository devices 111/113 may be securely distributed within the managed network 110.

The endpoints 106 may include hardware-based computer systems that are configured to communicate with the other components of the operating environment 100 via the network 121. The endpoints 106 may include any computer device that may be managed at least partially by the update device 104 and/or have been enrolled in one of the managed networks 110. Generally, the endpoints 106 include devices that are operated by the personnel and systems of an enterprise or store data of the enterprise. The endpoints 106 might include workstations of an enterprise, servers, data storage systems, printers, telephones, internet of things (IOT) devices, smart watches, sensors, automobiles, battery charging devices, scanner devices, etc. The endpoints 106 may also include virtual machines, which may include a portion of a single processing unit or one or more portions of multiple processing units, which may be included in multiple machines.

The endpoints 106 include the applications 122, the agents 124, the OS's 120, or some combinations thereof. The applications 122 may include applications, components, systems, drivers, of any kind or type. Some examples of the applications 122 may include software applications, enterprise software, hardware components, installed printers, memory locations, utilized monitors, ports, plug-ins, services, network communication components, the endpoint 106 itself (or information related thereto), similar computer-related features or components, or combinations thereof. The applications 122 may differ between the endpoints 106. For instance, the first endpoint 106A might have a processor with different capacity than the processor of the second endpoint 106B.

In the embodiment of FIG. 1, the first endpoint 106A includes a first OS 120A and a first application 122A configured to operate on the first OS 120A. The first OS 120A includes a non-Linux-based OS such as Window®, macOS®, etc. The first endpoint 106A may be updated without use of one of the repository devices 111/113. For instance, in general non-Linux based systems may benefit from wide scale implementation and uniform development, which may enable readily accessible product updates and wide availability of metadata associated with the product updates.

Additionally, the second and third endpoints 106B and 106C may include a second OS 120B. The second endpoint 106B may include a second application 122B and a third application 122C, which may be configured to operate on the second OS 120B. In the examples described in the present disclosure the second application 122B is different from and supplied by a different vendor than the third application 122C. The fourth application 122D is also configured to operate on the second OS 120B. The fourth application 122D may be substantially similar or the same as the second application 122B in some examples.

The second OS 120B may be a Linux-based OS. Accordingly, one or more of the second, third, and fourth applications 122B-122D may use one of the repository devices 111/113 during a patch operation. Additionally, the second, third, and fourth applications 122B-122D may have varied levels (e.g., some more and some less) of metadata associated with product updates.

In the embodiment of FIG. 1, the first managed network 110A includes two endpoints 106A and 106B. In some embodiments, the first managed network 110A may include a much larger number of non-Linux-based systems (e.g., 106A) than Linux-based systems (e.g., 106B). For instance, the first managed network 110A may include 70, 80, 90, or 100 times the number of non-Linux-based systems than Linux-based systems. In these embodiments, heterogenous-OS product update processes as described in the present disclosure may be particularly useful. For instance, the heterogenous-OS product update processes may enable the patch management of the non-Linux systems to integrate the Linux-based systems.

The endpoints 106 might also include one of the agents 124. The agent 124 may be configured to exist on the endpoints 106 to support ongoing management of the endpoints 106. In some embodiments, the update device 104 or the update management engine 107 may interface with the agent 124. For instance, the agent 124 may have a high level of privilege on the endpoint 106, which enables visibility of the agent 124 to the applications 122 as well as operational parameters related to or characterizing the applications 122. The agent 124 may interface with local applications (e.g., the search feature) and may support communication of information back to the update device 104.

In the embodiment of FIG. 1, the update management engine 107 may be configured to interface directly with the agent 124. For example, the agents 124 may be configured to generate the product update list. In some embodiments, the agents 124 generates the product update list based on an inquiry communicated to one of the repository devices 111/113 and/or product information accessed by the agent 124 at the endpoints 106. The agents 124 may then communicate the product update list to the update device 104 to enable evaluation of outstanding product updates, metadata available at the repository devices 111/113, the applications 122 that are in an unpatched state, repository information, other data, or combinations thereof.

In some embodiments, the agents 124 may also receive and/or at least partially implement update packages. For instance, the update management engine 107 may generate the update packages and communicate the update packages to the endpoints 106. The agents 124 may receive the update package and communicate the update package to the application 122 for local implementation at the endpoints 106.

The update device 104 includes a hardware-based computing system that is configured to communicate with other components of the operating environment 100 via the network 121. The update device 104 includes an update management engine 107 that is configured to update the applications 122 in the managed networks 110.

The update device 104 may also include the policy 109. The policy 109 is configured to trigger an automated product update operation. The policy 109 is customizable. For instance, the policy 109 may trigger the automated product update operation based on metadata associated with product updates or lack of metadata associated with product updates. The metadata may include one or more values of characteristics of the product update. Responsive to the values being a defined parameter of the policy 109, the update management engine 107 may initiate generation of an update package and distribution thereof.

In Linux-based systems, (e.g., using the second OS 120B), the policy 109 may dictate what information is necessary to evaluate a product update. For instance, the policy 109 may trigger update operations based on a CVE risk level. This information may not be included in the metadata that is available at the repository device 111/113. Accordingly, the update management engine 107 may parse the metadata to determine whether the metadata includes values for the one or more characteristics at one of the repository devices 111/113. Responsive to the metadata not including values, the update management engine 107 may request the values for the one or more characteristics from the outside source 108, for instance.

In some embodiments, the policy 109 may include a default distribution functionality. The default distribution functionality may configure the update device 104 to trigger the update operation in circumstances in which there is insufficient metadata associated with an outstanding update. In these circumstances, the criticality (e.g., the CVE risk level), severity, type of the related product update may not be known. Accordingly, the default distribution functionality allows treatment of the outstanding update with insufficient metadata as critical, which may be automatically and/or immediately addressed through distribution of the update.

The policy 109 may also be endpoint-specific. For instance, the policy 109 may trigger an update operation on the first endpoint 106A based on different values than on the second endpoint 106B.

In addition, the update management engine 107 may be configured to update the applications 122 in a heterogenous OS environment. The update of the applications 122 in the heterogenous OS environment may include distribution of a product update in a Linux-based system (e.g., the second endpoint and the third endpoint 106C) as well as a non-Linux-based system (e.g., the first endpoint 106A).

For instance, the update management engine 107 may receive from the second vendor device 102, a first update configured modify the first application 122A on the first endpoint 106A and first metadata associated with the first update. The update management engine 107 may generate a first update package based on the first metadata. The first update package includes a command and data sufficient to implement the first update on the first endpoint 106A. The update management engine 107 may distribute the first update and the first update package to the first endpoint 106A such that the first endpoint 106A implements the first update according to the first update package to modify the first application 122A.

Additionally, the update management engine 107 may access data and information from the agents 124. For instance, the update management engine 107 may access or receive the product update list that identifies the applications 122 on the endpoint 106 that is in an unpatched state. Additionally or alternatively, the update management engine 107 may access repository information of the repository device 111/113 with which the endpoint 106 communicates to access a product update associated with the unpatched application 122.

Based on the repository information, the update management engine 107 may access, the product update and metadata associated with the product update from the repository device 111/113 identified in the repository information.

The update management engine 107 may generate an update package based on the metadata and/or the product update. The update package includes one or more commands and data sufficient to implement the product update on the endpoint 106. The update management engine 107 may distribute the product update and the update package. Distribution is configured such that the endpoint 106 locally implements the product update according to the update package to modify the unpatched application 122.

The update management engine 107 may also be configured to distribute the update package to other endpoints 106 implementing substantially similar or the same application 122. For instance, the update management engine 107 may determine that the fourth application 122D on the third endpoint 106C is the same or substantially the same as the second application 122B on the second endpoint 106B. In response to the determination, the update management engine 107 may distribute the product update and the update package previously distributed to the second endpoint 106B to the third endpoint 106C.

In some embodiments, the update management engine 107 may be configured to parse the metadata to determine whether metadata associated with the product update includes values utilized by the policy 109 to trigger or not trigger one or more automated update operations. Responsive to the metadata accessed from the repository device 111/113 being insufficient, the update management engine 107 may be configured to obtain outside metadata from the outside source 108. In these circumstances, the update package may be generated based at least partially on the outside metadata accessed from the outside source 108.

Additionally or alternatively, responsive to the metadata accessed from the repository device 111/113 being insufficient, the update management engine 107 may be configured to default to trigger the automated update operation. For instance, the update management engine 107 may be configured such that a lack of metadata or an insufficient amount of metadata may trigger generation of the update package to include an update file and little or nothing else. The endpoints 106 may install the update based on the generated update package.

The agent 124, the OS's 120, the applications 122, the policy 109, the update management engine 107, and components thereof may be implemented using hardware including a processor, a microprocessor (e.g., to perform or control performance of one or more operations), a field-programmable gate array (FPGA), or an application-specific integrated circuit (ASIC). In some other instances, the agent 124, the OS's 120, the applications 122, the policy 109, the update management engine 107, and components thereof may be implemented using a combination of hardware and software. Implementation in software may include rapid activation and deactivation of one or more transistors or transistor elements such as may be included in hardware of a computing system (e.g., the endpoints 106 or the update device 104 of FIG. 1). Additionally, software defined instructions may operate on information within transistor elements. Implementation of software instructions may at least temporarily reconfigure electronic pathways and transform computing hardware.

Modifications, additions, or omissions may be made to the operating environment 100 without departing from the scope of the present disclosure. For example, the operating environment 100 may include one or more managed networks 110, one or more update devices 104, one or more vendor devices 102/104, one or more vendor devices 102/104, one or more outside sources 108, one or more repository devices 111/113, one or more endpoints 106, or any combination thereof. Moreover, the separation of various components and devices in the embodiments described herein is not meant to indicate that the separation occurs in all embodiments. Moreover, it may be understood with the benefit of this disclosure that the described components and servers may generally be integrated together into a single component or server or separated into multiple components or servers.

FIGS. 2A-2C depict a heterogeneous-OS product update process (process 200) that may be implemented in an operating environment such as the operating environment 100 of FIG. 1. FIGS. 2A-2C include one or more subsets of components (e.g., 102, 104, 107, 109, 111, 110, 106, 108, 120, 122, 124, etc.). Description of these components are not repeated with reference to FIGS. 2A-2C. Although not depicted in FIGS. 2A-2C, communication of data and information in the process 200 may be via a network such as the network 121 of FIG. 1.

The process 200 is separating into three subprocess 201A, 201B, and 201C of FIGS. 2A, 2B, and 2C, respectively. A first subprocess 201A of FIG. 2A depicts an update process of the first application 122A and the second application 122B. A second subprocess 201B depicts a second update process of the third application 122C. A third subprocess 201C of FIG. 2C depicts a third update process of the fourth application 122D on the third endpoint 106C. Each of the subprocesses 201A-201C are described independently. It should be appreciated with the benefit of this disclosure that two or more of the subprocesses 201A-201C may be implemented in some embodiments.

FIG. 2A depicts the first subprocess 201A. In the first subprocess 201A, the second endpoint 106B and the first endpoint 106A of the first managed network 110A are updated. The first endpoint 106A includes the first OS 120A, which is a non-Linux-based OS such as Windows® or macOS®. The second endpoint 106B includes the second OS 120B, which is a Linux-based OS such as Debian, Fedora Linux, and Ubuntu. Although the first managed network 110A includes the first endpoint 106A as the only endpoint with the non-Linux-based OS, some embodiments of the process 200 may implement hundreds or thousands of endpoints 106 implementing the non-Linux-based OS.

The first subprocess 201A enables update of the first application 122A on the first endpoint 106A as well as the second application 122B of the second endpoint 106B. Embodiments of the present disclosure may enable distribution of updates (e.g., 208 and 210) to the applications 122 in the first managed network 110A having endpoints 106 with differing OS's 120.

The first subprocess 201A includes a conventional updating of the first application 122A. For instance, the update management engine 107 may be configured to receive a first update and first metadata 202. The first update and first metadata 202 may be received from a second vendor device 102 or the outside source 108 in some instances. The first update and/or first metadata 202 may be configured to modify the first application 122A on the first endpoint 106A. For example, the first application 122A may include an Adobe® product. Accordingly, the second vendor device 102 may include an Adobe vendor device on which the first update and the first metadata 202 may be accessible. In this example, the first update and first metadata 202 may include a patch, product update, etc. and information related to the patch, product update, etc. such as affected products, a purpose, a criticality, a description of a vulnerability addressed, etc. The update management engine 107 may access the first update and the first metadata 202 from the second vendor device 102 or the second vendor device 102 may communicate the first update and first metadata 202 to the update device 104.

The update management engine 107 may interface with the policy 109 to determine whether the first update is distributed to the first endpoint 106A. For instance, the policy 109 may direct the update management engine 107 to distribute certain updates according to characteristics of the updates. Some examples of the characteristics may include a vendor, a product, a criticality of the update, a risk related to the update, successful distribution to other endpoints, etc.

Referring back to the example above, the policy 109 may automatically distribute all updates from Adobe. Alternatively, the policy 109 may automatically distribute all updates from Adobe that address a critical vulnerability, etc. In response to the policy 109 dictating that the first update and first metadata 202 is distributed.

For instance, the update management engine 107 may generate a first update package 210. The first update package may be based on the first metadata. The first update package may include a command and data sufficient to implement the first update on the first endpoint 106A. The update management engine 107 may distribute the first update package 210, which may include the first update, to the first endpoint 106A such that the first endpoint 106A implements the first update according to the first update package 210 to modify the first application 122A.

The first update subprocess 201A includes an update of the second application 122B on the second endpoint 106B. The second endpoint 106B operates the second OS 120, which may be a Linux-based OS. Accordingly, the second application 122B is configured to operate in a Linux-based environment.

To update the second application 106B a first repository device 111 may be implemented in the first managed network 110A. The first repository device 111 is a device with which the second endpoint 106B communicates to access a second update associated with the second application 122B. The first repository device 111 may be configured to copy at least a portion of information and data on a first vendor device 103. For instance, a vendor of the second application 122B may post updates such as programing instructions and executables for new application versions, patches, metadata related to patches, etc. to the first vendor device 103. The first repository device 111 may be configured to access at least a portion of the data and information on the first vendor device 103.

In some embodiments, the first repository device 111 may be specifically configured for the second application 122B. For instance, the administrator 112 may set up the first repository device 111 to access, receive, or store the updates and metadata from the first vendor device 103 related to the second application 122B. The administrator 112 may access the information (updates and metadata) from the first vendor device 103 and store the information at the first repository device 111.

The first repository device 111 is included in the first managed network 110A and may be communicatively coupled to the first vendor device 103, which may be outside the first managed network 110A. Accordingly, management operations may be performed at the first repository device 111 to ensure functionality and security of the first repository device 111. In some embodiments, the first repository device 111 may not be included in the first managed network 110A. Instead, the first repository device 111 may not be managed as a component of the first managed network 110A.

To update the second application 122B, the update management engine 107 may access a product update list 214. The product update list 214 may be accessed from the second agent 124A on the second endpoint 106B. The product update list 214 identifies the second application 122B on the second endpoint 106B that is in an unpatched state. Additionally, repository information 206 of the first repository device 111 may be communicated by the second agent 124A to the update device 104. The repository information 206 includes information such as network address (IP address) of the first repository device 111. The repository information 206 may enable the update management engine 107 to communicate with the first repository device 111.

In some embodiments, the repository information 206 may be included in the product update list 214. For instance, the product update list 214 may identify one or more applications 122 on the second endpoint 106B in an unpatched state as well as repository information 206 related to each of the one or more identified applications 122.

In some embodiments, the product update list 214 is generated by the second agent 124A. For instance, the second agent 124A may have a high level of access to operational information and product information on the second endpoint 106B such the applications 122 loaded on the second endpoint 106B, hardware components implemented at the second endpoint 106B, users associated with the second endpoint 106B, roles of the users, locations of the second endpoint 106B, etc. The second agent 124A may generate an inquiry configured to identify any updates available on the first repository device 111 related to any of the applications 122 of the second endpoint 106B. The inquiry may be communicated by the second agent 124A to the first repository device 111.

Based at least partially on the repository information 206, the update management engine 107 accesses the second update and second metadata 212 from the first repository device 111. The update management engine 107 may parse the second update and second metadata 212 to determine whether the second update includes one or more characteristics that trigger one or more automated update operations of the second application 122B.

As described with respect to the first application 122A, the policy 109 may dictate values and characteristics of the second update and second metadata 212 that trigger the automated update operations of the second application 122B. The policy 109 is configured to trigger an automated product update operation based on one or more values in the second metadata.

The update management engine 107 may parse the second update and second metadata 212 to determine whether the second update and second metadata 212 includes information used by the policy 109. Responsive to the second update and second metadata 212 not including sufficient information for the policy 109, the update management engine 107 may access an outside source 108. For instance, the update device 104 may request one or more values from the outside source 108. Additionally or alternatively, the administrator 112 or another entity may push the one or more values to the update device 104 from the outside source 108 as outside metadata 204.

For example, in some embodiments, the outside source 108 includes a common vulnerabilities and exposures (CVE) host site, a vulnerabilities management and prioritization site, or another site on which information related to patches is available. The CVE host site or the other outside source 108 may communicate the outside metadata 204 to the update device 104.

The update management engine 107 may obtain the outside metadata 204 from the outside source 108. The outside metadata 204 may include, for example, one or more or a combination of a security or risk rating of the second update, a system affected by the second update, a patch type, a patch source, and a vulnerability severity. The update management engine 107 may trigger the automated update operations based on application of the second update and second metadata 212 and the outside metadata 204 to the policy 109.

Additionally or alternatively, responsive to the second update and second metadata 212 not including sufficient information for the policy 109, the update management engine 107 may default to triggering the automated update operation. For instance, in these and other embodiments, the update management engine 107 may not access an outside source 108 or the outside metadata 204 may be unavailable. Accordingly, the second metadata 212 may be insufficient for the update management engine 107 to evaluate whether or not to patch the second application 122B. Thus, the update management engine 107 may automatically trigger the automated update operation.

Responsive to the second update and second metadata 212 including sufficient information, the update management engine 107 may trigger the automated update operations based on application of the second update and second metadata 212 to the policy 109.

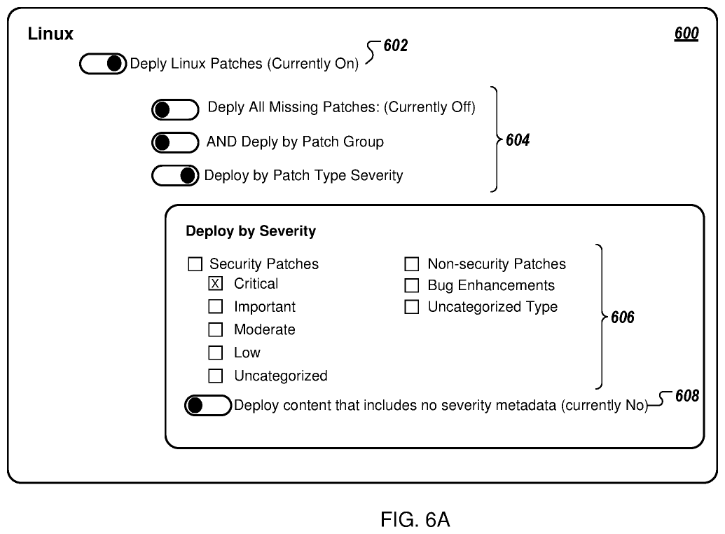

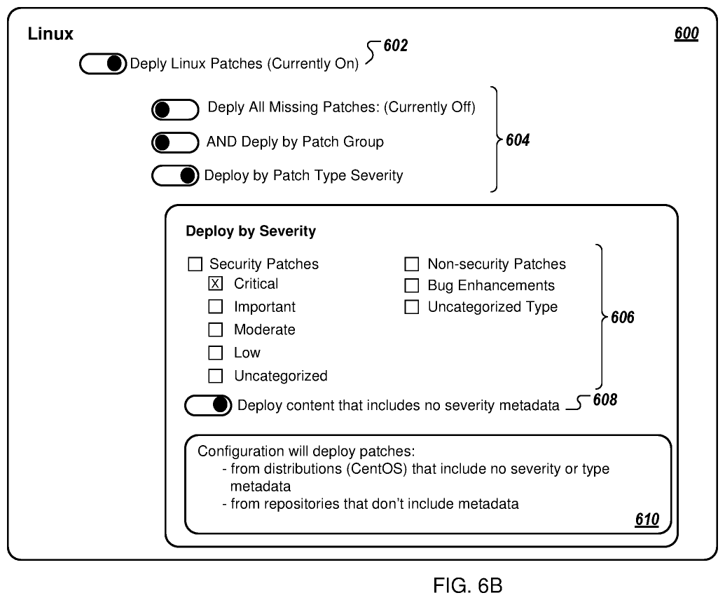

For instance, with reference to FIGS. 6A and 6B an example user interface (UI) 600 may be implemented in the process 200. The UI 600 enables specification of a portion of a policy related to product updates in Linux-based OS. The UI includes a first selection field that enables selection of patching Linux patches. In FIGS. 6A and 6B, the selection is made to deploy Linux patches. Additionally, the UI 600 enables other configurations 604 such as deploying all missing patches, deploying by patch groups, and deploying by patch type severity. In FIGS. 6A and 6B, the deploying by patch type severity is selected, which may enable an additional selection field 606 in which options may be selected. In FIGS. 6A and 6B, a box next to a critical patches is selected, which indicates critical patches may be automatically deployed or distributed.

Referring to FIG. 6A, a default distribution functionality field 608 is provided in the UI 600. In FIG. 6A, the default distribution functionality field 608 is not selected. Accordingly, in the absence of severity metadata, a corresponding product update is not deployed. Referring to FIG. 6B, the default distribution functionality field 608 is selected. Accordingly, in the absence of severity metadata, a corresponding product update is deployed. An explanatory box 610 describes the conditions under which the product update is deployed responsive to selection of the default distribution functionality field 608.

The automated update operations may include generation and distribution of a second update package 208. For example, the update management engine 107 may generate a second update package 208 based on the second metadata and/or the outside metadata 204 if it is available or based on executables and product update files available at the first repository device 111. The second update package 208 includes a command and data sufficient to implement the second update on the second endpoint 106B. The update management engine 107 may distribute the second update and/or the second update package 210. The distribution may be configured such that the second endpoint 106B locally implements the second update according to the second update package 208 to modify the second application 122B.

FIG. 2B depicts the second subprocess 201B of the process 200. The second subprocess 201B may be implemented with the first subprocess 201A and/or the third subprocess 201C of FIGS. 2A and 2C. In the second subprocess 201B, the third application 122C at the second endpoint 106B of the first managed network 110A is updated.

Similar to the second application 122B, the third application 122C is configured to operate with the second OS 120B, which may be a Linux-based OS. The third application 122C may be configured to interface with the second repository device 113. The second repository device 113 may be further configured to communicate with a third vendor device 228. The third vendor device 228 may be associated with a developer or a vendor of the third application 122C. For instance, the vendor of the third application 122C may post or push data and information related to product updates of the third application 122C to the second repository device 113.

In the embodiment of FIG. 2B, the second repository device 113 is outside the first managed network 110A. In other embodiments, the second repository device 113 may be within the first managed network 110A. The second repository device 113 may be otherwise substantially similar to the first repository device 111.

In the second subprocess 201B, the second agent 124A may communicate the product update list 214. The product update list 214 may indicate that the third application 122C is unpatched. In addition, the second agent 124A may communicate second repository information 216 related to the second repository device 113.

The update management engine 107 may receive the product update list 214 and the second repository information 216. Based on the second repository information 216, the update management engine 107 may access the third update and third metadata 220 from a second repository device 113. The third update may be a patch or version change directed to the third application 122C. The third metadata 220 may include information and values related characteristics of the third update.

As described with reference to FIG. 2A, the update management engine 107 is configured to parse the third update and third metadata 220 to determine whether the third metadata includes values used by the policy 109. Again, the policy 109 may trigger one or more automated update operations based on one or more values of one or more characteristics of the third update. Accordingly, if the one or more values are not present in the third metadata, the update management engine 107 may request outside metadata 204 from the outside source 108 or may default to triggering the distribution of the third update or a third update package 222 configured to install the third update.

The update management engine 107 may generate the third update package 222. The third update package 222 may be based on the third metadata and/or the outside metadata 204. The third update package 222 includes a command and data sufficient to implement the third update on the second endpoint 106B to modify the third application 122C.

The update management engine 107 may distribute the third update and the third update package 222. The distribution is configured such that the second endpoint 106B locally implements the third update according to the third update package 222 to modify the third application 122C.

FIG. 2C depicts the third subprocess 201C of the process 200. The third subprocess 201C may be implemented with the first subprocess 201A and/or the second subprocess 201B of FIGS. 2A and 2B. In the third subprocess 201C, the fourth application 122D at the third endpoint 106C of the second managed network 110B is updated.

In the third subprocess 201C, the fourth application 122D and the second OS 120B may communicate application and operating system information 234 to the third agent 124B of the third endpoint 106C. The third agent 124B may then communicate third endpoint information 232 to the update device 104. The third endpoint information 232 may include information identifying the second OS 120B on the third endpoint 106C and the fourth application 122D on the third endpoint 106C.

The update device 104 or the update management engine 107 may determine that the third endpoint 106C includes the second OS 120B and that the fourth application 122D is the second application 122B of FIG. 2A. Accordingly, the third endpoint 106C includes the same OS and the same application 122 as the second endpoint 106B, but is included in the second managed network 110B.

In response to the determination that the third endpoint 106C includes the second OS 120B and second application 122B/122D, the update device 104 may distribute the second update and the second update package 208 to the third endpoint 106C. In some embodiments, the first managed network 110A may be associated with a first entity and the second managed network 110B may be associated with a second entity. Accordingly, the second update package 208 developed for the first managed network 110A of the first entity may be used to patch or update other endpoints 106 in other managed networks 110 when the OS and the application 122 are the same or substantially similar.

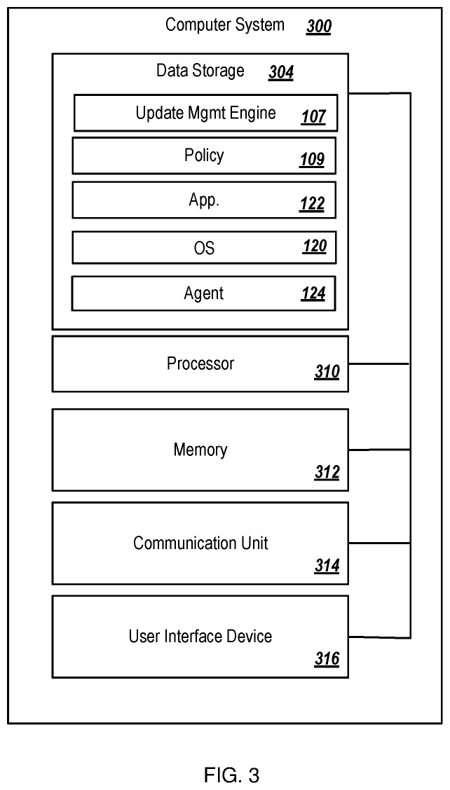

FIG. 3 illustrates an example computer system 300 configured for computer software update in a managed network that includes endpoints having heterogenous operating systems, according to at least one embodiment of the present disclosure. The computer system 300 may be implemented in the operating environment 100 FIG. 1, for instance. Examples of the computer system 300 may include the update device 104, one or more of the endpoints 106, the second vendor device 102, the first vendor device 103, the first repository device 111, the second repository device 113, the outside source 108 or some combination thereof. The computer system 300 may include one or more processors 310, a memory 312, a communication unit 314, a user interface device 316, and a data storage 304 that includes one or more or a combination of the policy 109, the update management engine 107, the OS's 120, the applications 122, the agents 124, (collectively, system modules).

The processor 310 may include any suitable special-purpose or general-purpose computer, computing entity, or processing device including various computer hardware or software modules and may be configured to execute instructions stored on any applicable computer-readable storage media. For example, the processor 310 may include a microprocessor, a microcontroller, a digital signal processor (DSP), an ASIC, an FPGA, or any other digital or analog circuitry configured to interpret and/or to execute program instructions and/or to process data. Although illustrated as a single processor in FIG. 3, the processor 310 may more generally include any number of processors configured to perform individually or collectively any number of operations described in the present disclosure. Additionally, one or more of the processors 310 may be present on one or more different electronic devices or computing systems. In some embodiments, the processor 310 may interpret and/or execute program instructions and/or process data stored in the memory 312, the data storage 304, or the memory 312 and the data storage 304. In some embodiments, the processor 310 may fetch program instructions from the data storage 304 and load the program instructions in the memory 312. After the program instructions are loaded into the memory 312, the processor 310 may execute the program instructions.

The memory 312 and the data storage 304 may include computer-readable storage media for carrying or having computer-executable instructions or data structures stored thereon. Such computer-readable storage media may include any available media that may be accessed by a general-purpose or special-purpose computer, such as the processor 310. By way of example, and not limitation, such computer-readable storage media may include tangible or non-transitory computer-readable storage media including RAM, ROM, EEPROM, CD-ROM or other optical disk storage, magnetic disk storage or other magnetic storage devices, flash memory devices (e.g., solid state memory devices), or any other storage medium which may be used to carry or store desired program code in the form of computer-executable instructions or data structures and that may be accessed by a general-purpose or special-purpose computer. Combinations of the above may also be included within the scope of computer-readable storage media. Computer-executable instructions may include, for example, instructions and data configured to cause the processor 310 to perform a certain operation or group of operations.

The communication unit 314 may include one or more pieces of hardware configured to receive and send communications. In some embodiments, the communication unit 314 may include one or more of an antenna, a wired port, and modulation/demodulation hardware, among other communication hardware devices. In particular, the communication unit 314 may be configured to receive a communication from outside the computer system 300 and to present the communication to the processor 310 or to send a communication from the processor 310 to another device or network (e.g., the network 121 of FIG. 1).

The user interface device 316 may include one or more pieces of hardware configured to receive input from and/or provide output to a user. In some embodiments, the user interface device 316 may include one or more of a speaker, a microphone, a display, a keyboard, a touch screen, or a holographic projection, among other hardware devices.

The system modules may include program instructions stored in the data storage 304. The processor 310 may be configured to load the system modules into the memory 312 and execute the system modules. Alternatively, the processor 310 may execute the system modules line-by-line from the data storage 304 without loading them into the memory 312. When executing the system modules, the processor 310 may be configured to perform one or more processes or operations described elsewhere in this disclosure.

Modifications, additions, or omissions may be made to the computer system 300 without departing from the scope of the present disclosure. For example, in some embodiments, the computer system 300 may not include the user interface device 316. In some embodiments, the different components of the computer system 300 may be physically separate and may be communicatively coupled via any suitable mechanism. For example, the data storage 304 may be part of a storage device that is separate from a device, which includes the processor 310, the memory 312, and the communication unit 314, that is communicatively coupled to the storage device. The embodiments described herein may include the use of a special-purpose or general-purpose computer including various computer hardware or software modules, as discussed in greater detail below.

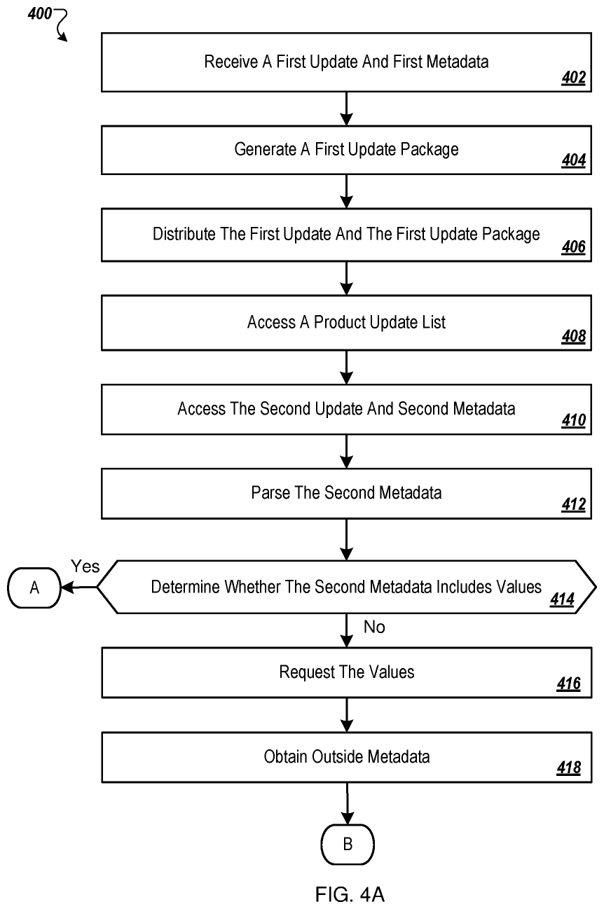

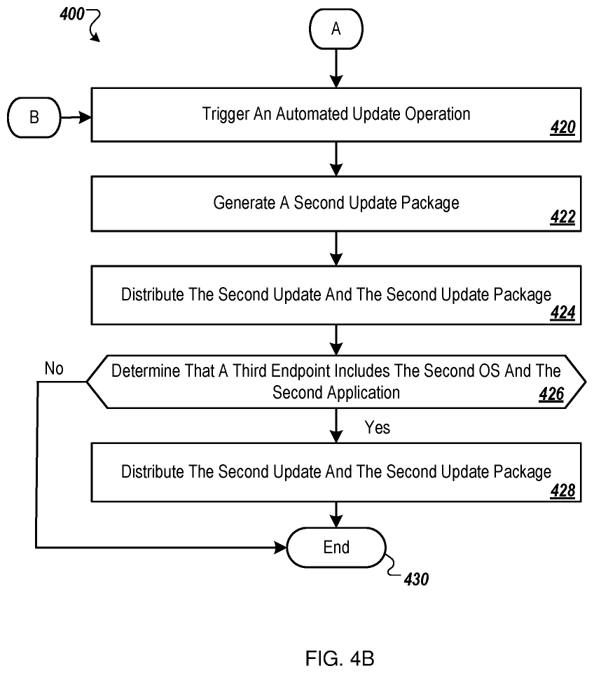

FIGS. 4A and 4B are a flow chart of an example method 400 of computer software update in a managed network that includes endpoints having heterogenous operating systems (e.g., one or more Linux-based OS and one or more non-Linux-based OS) according to at least one embodiment of the present disclosure. The method 400 may be performed in any suitable operating environment such as the operating environment 100 of FIG. 1. One or more operations of the method 400 may be performed by a computing device such as the update device 104, the computing system 300 of FIG. 3, or another suitable system, apparatus, or device.

Referring to FIG. 4A, the method 400 may begin at block 402 in which a first update and first metadata is received. The first update may be received from a second vendor device. The first update may be configured to modify a first application on a first endpoint. The first metadata is associated with the first update. The first endpoint may be included in a manage network and the first endpoint may implement a first OS. The first application may be configured to operate on or via the first OS. In some embodiments, the first OS includes a non-Linux-based OS.

At block 404, a first update package may be generated. The first update package may be based on the first metadata. The first update package may include a command and/or data sufficient to implement the first update on the first endpoint. At block 406, the first update and the first update package may be distributed. The first update and the first update package may be distributed to the first endpoint such that the first endpoint implements the first update according to the first update package to modify the first application.

At block 408, a product update list may be accessed. The product update list may be accessed from an agent of a second endpoint. The second endpoint may be included in the managed network with the first endpoint. The second endpoint may implement a second OS, which is a Linux-based OS. In some embodiments, the product update list may identify a second application on the second endpoint that is in an unpatched state. Additionally, the product update list may include repository information of a repository device with which the second endpoint communicates to access a second update associated with the second application. The second application is configured to operate on the second OS.

In some embodiments, the product update list may be generated based on an inquiry. For example, the agent may be installed at the second endpoint and have ongoing access to information related to software and hardware implemented at the second endpoint. The agent may communicate the inquiry to the repository device to obtain update status information related to the second application, other applications, hardware, etc. at the second endpoint.

At block 410, the second update and second metadata may be accessed. The second update and second metadata may be accessed from a repository device. The second update and second metadata may be accessed based on the repository information. In some embodiments, the repository device may be communicatively coupled to a first vendor device that operates outside the managed network. Additionally, in these and other embodiments, the repository device may be implemented in the managed network and may include a copy of product update information provided by the first vendor device. Additionally or alternatively, the repository device may include an entity-specific repository device. The entity-specific repository device may be developed by an administrator of the managed network.

At block 412, the second metadata may be parsed. The second metadata may be parsed to determine whether the second update includes a characteristic that triggers one or more automated update operations of the second application. At block 414, it may be determined whether the second metadata includes values for the one or more characteristics at the repository device. For instance, it may be determined whether the values for the one or more characteristics are available at the repository device or whether such values are only accessible from another source.

In response to the second metadata at the repository device not including the values, (“No” at block 414), the method 400 may proceed to block 416. In response to the second metadata at the repository device including the values, (“Yes” at block 414), the method 400 may proceed to block 420 of FIG. 4B. At block 416, the values may be requested. For instance, the values for the one or more characteristics may be requested from an outside or public source. At block 418, outside metadata may be obtained from the outside source. The outside or public source may include a common vulnerabilities and exposures (CVE) host site or a vulnerabilities management and prioritization site. The outside metadata may include a security or risk rating of the second update, a system affected by the second update, a patch type, a patch source, a vulnerability severity, another characteristic of the second update, or combinations thereof.

Referring to FIG. 4B, at block 420, one or more automated update operations may be triggered. The automated update operations may be triggered according to a policy. The policy may identify one or more characteristics of an update. Responsive to the one or more characteristics of the second update conforms to the policy (e.g., the second update includes a particular value for a particular characteristic), the automated update operations are triggered.

In some embodiments, the automated update operations may include one or more steps such as blocks 422, 424, 426, 428, or some combination thereof. For instance, at block 422, a second update package may be generated. The second update package may be generated based at least in part on the second metadata. The second update package may include one or more commands and data sufficient to implement the second update on the second endpoint. In some embodiments, the second update package is generated based at least partially on the outside metadata. At block 424, the second update and the second update package may be distributed. The second update and the second update package may be distributed to the second endpoint. The distribution may be configured such that the second endpoint locally implements the second update according to the second update package to modify the second application.

At block 426, it may be determined whether that a third endpoint includes the second OS and the second application. In response to the third endpoint including the second OS and the second application (“YES” at block 426), the method 400 may proceed to block 428. In response to the third endpoint not including the second OS or the second application (“No” at block 426), the method 400 may proceed to block 430, at which the method 400 may end.

At block 428, the second update and the second update package may be distributed. The second update and the second update package may be distributed to the third endpoint. In some embodiments, the third endpoint may be included in a second managed network, which may be associated with a second entity. In these and other embodiments, the first endpoint and the second endpoint may be included in a first managed network associated with a first entity.

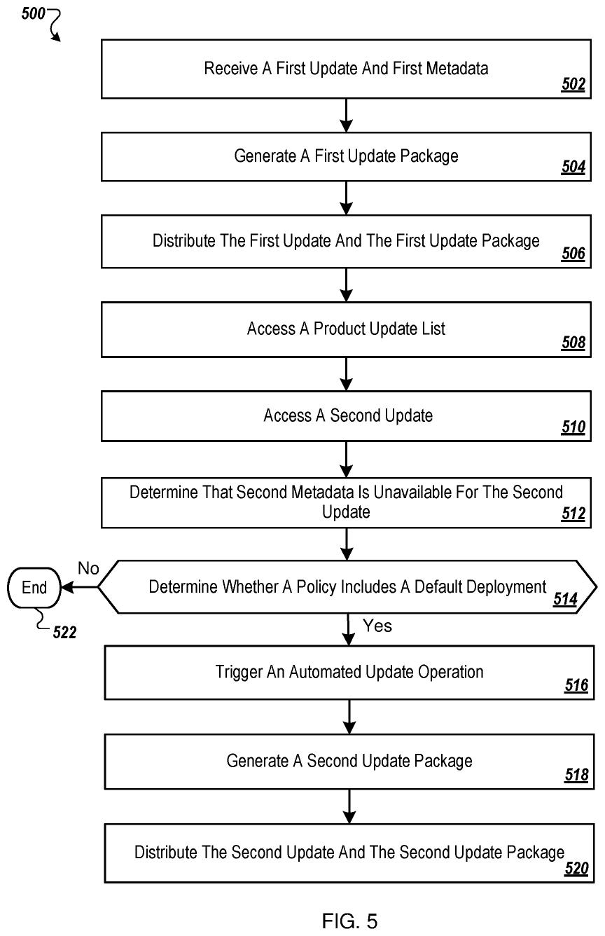

FIG. 5 a flow chart of an example method 500 of computer software update in a managed network that includes endpoints having heterogenous operating systems (e.g., one or more Linux-based OS and one or more non-Linux-based OS) according to at least one embodiment of the present disclosure. The method 500 may be performed in any suitable operating environment such as the operating environment 100 of FIG. 1. One or more operations of the method 500 may be performed by a computing device such as the update device 104, the computing system 300 of FIG. 3, or another suitable system, apparatus, or device.

The method 500 may begin at block 502 in which a first update and first metadata is received. The first update may be received from a second vendor device. The first update may be configured to modify a first application on a first endpoint. The first metadata is associated with the first update. The first endpoint may be included in a manage network and the first endpoint may implement a first OS. The first application may be configured to operate on or via the first OS. In some embodiments, the first OS includes a non-Linux-based OS.

At block 504, a first update package may be generated. The first update package may be based on the first metadata. The first update package may include a command and/or data sufficient to implement the first update on the first endpoint. At block 506, the first update and the first update package may be distributed. The first update and the first update package may be distributed to the first endpoint such that the first endpoint implements the first update according to the first update package to modify the first application.

At block 508, a product update list may be accessed. The product update list may be accessed from an agent of a second endpoint. The second endpoint may be included in the managed network with the first endpoint. The second endpoint may implement a second OS, which is a Linux-based OS. In some embodiments, the product update list may identify a second application on the second endpoint that is in an unpatched state. Additionally, the product update list may include repository information of a repository device with which the second endpoint communicates to access a second update associated with the second application. The second application is configured to operate on the second OS.

In some embodiments, the product update list may be generated based on an inquiry. For example, the agent may be installed at the second endpoint and have ongoing access to information related to software and hardware implemented at the second endpoint. The agent may communicate the inquiry to the repository device to obtain update status information related to the second application, other applications, hardware, etc. at the second endpoint.

At block 510, the second update may be accessed. The second update may be accessed from a repository device. The second update may be accessed based on the repository information. In some embodiments, the repository device may be communicatively coupled to a first vendor device that operates outside the managed network. Additionally, in these and other embodiments, the repository device may be implemented in the managed network and may include a copy of product update information provided by the first vendor device. Additionally or alternatively, the repository device may include an entity-specific repository device. The entity-specific repository device may be developed by an administrator of the managed network.

At block 512, it may be determined that the second metadata is unavailable for the second update. For instance, the repository device does not include metadata related to the second update that indicates one or more characteristics of the second update. For instance, metadata indicating a severity of the second update or a type of the second update may be unavailable.

At block 514, it may be determined whether a policy includes a default deployment configuration. The default deployment configuration may trigger distribution of the second update in the absence of the second metadata. Responsive to the policy including the default deployment configuration (“Yes” at block 514), the method 500 may proceed to block 516. Responsive to the policy not including the default deployment configuration (“No” at block 514), the method 500 may proceed to block 522, in which the method 500 ends (block 522).

At block 516, one or more automated update operations may be triggered. The automated update operations may be triggered according to the policy. In some embodiments, the automated update operations may include one or more steps such as one or both of blocks 518 and 522. For instance, at block 518, a second update package may be generated. Because the second update does not have related second metadata, the second update package may only include information and data implemented to locally install the second update. For instance, an executable or link to an executable may be included in the second update package. The second update package may include one or more commands and/or other data sufficient to implement the second update on the second endpoint.

At block 520, the second update and/or the second update package may be distributed. The second update and the second update package may be distributed to the second endpoint. The distribution may be configured such that the second endpoint locally implements the second update according to the second update package to modify the second application.

Further, modifications, additions, or omissions may be made to the methods 400 and 500 without departing from the scope of the present disclosure. For example, the operations of the methods 400 and 500 may be implemented in differing order. Furthermore, the outlined operations and actions are only provided as examples, and some of the operations and actions may be optional, combined into fewer operations and actions, or expanded into additional operations and actions without detracting from the disclosed embodiments. For example, in some embodiments, the policy is configured to trigger one or more automated update operations at the second endpoint. The policy may be configured to trigger the automated update operations based on one or more values in the second metadata. In these and other embodiments, generation of the second update package and the distribution of the second update and the second update package is based on the policy.

Additionally, in some embodiments, there may be multiple repository devices. Repository information regarding the multiple repository devices may be communicated in the managed network or the operating environment. In these and other embodiments, the product update list further may identify a third application on the second endpoint that is in an unpatched state and second repository information of a second repository device with which the second endpoint communicates to access a third update associated with the third application. Based on the second repository information, the third update and third metadata associated with the third update may be accessed from the second repository device. A third update package may be generated based on the third metadata. The third update package may include a command and data sufficient to implement the third update on the second endpoint. The third update and the third update package may be distributed. The distribution may be configured such that the second endpoint locally implements the third update according to the third update package to modify the third application.

The embodiments described herein may include the use of a special purpose or general-purpose computer including various computer hardware or software modules, as discussed in greater detail below.

Embodiments described herein may be implemented using computer-readable media for carrying or having computer-executable instructions or data structures stored thereon. Such computer-readable media may be any available media that may be accessed by a general purpose or special purpose computer. By way of example, and not limitation, such computer-readable media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store desired program code in the form of computer-executable instructions or data structures and which may be accessed by a general purpose or special purpose computer. Combinations of the above may also be included within the scope of computer-readable media.

Computer-executable instructions may include, for example, instructions and data, which cause a general-purpose computer, special purpose computer, or special purpose processing device (e.g., one or more processors) to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the terms “module” or “component” may refer to specific hardware implementations configured to perform the operations of the module or component and/or software objects or software routines that may be stored on and/or executed by general purpose hardware (e.g., computer-readable media, processing devices, etc.) of the computing system. In some embodiments, the different components, modules, engines, and services described herein may be implemented as objects or processes that execute on the computing system (e.g., as separate threads). While some of the system and methods described herein are generally described as being implemented in software (stored on and/or executed by general purpose hardware), specific hardware implementations or a combination of software and specific hardware implementations are also possible and contemplated. In this description, a “computing entity” may be any computing system as previously defined herein, or any module or combination of modulates running on a computing system.

The various features illustrated in the drawings may not be drawn to scale. The illustrations presented in the present disclosure are not meant to be actual views of any particular apparatus (e.g., device, system, etc.) or method, but are representations employed to describe embodiments of the disclosure. Accordingly, the dimensions of the features may be expanded or reduced for clarity. In addition, some of the drawings may be simplified for clarity. Thus, the drawings may not depict all of the components of a given apparatus (e.g., device) or all operations of a particular method.

Terms used in the present disclosure and the claims (e.g., bodies of the appended claims) are intended as “open” terms (e.g., the term “including” should be interpreted as “including, but not limited to,” the term “having” should be interpreted as “having at least,” the term “includes” should be interpreted as “includes, but is not limited to,” among others). Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in instances in which a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. Further, any disjunctive word or phrase presenting two or more alternative terms should be understood to contemplate the possibilities of including one of the terms, either of the terms, or both terms. For example, the phrase “A or B” should be understood to include the possibilities of “A” or “B” or “A and B.”

However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

The terms “first,” “second,” “third,” etc., are not necessarily used to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms “first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art and are to be construed as being without limitation to such specifically recited examples and conditions. Although embodiments of the present inventions have been described in detail, it should be understood that the various changes, substitutions, and alterations could be made hereto without departing from the scope of the invention.

What is claimed is:

1. A system, comprising:
a repository device that is communicatively coupled to a first vendor device that operates outside a managed network;
a first endpoint of the manage network that implements a first operating system (OS) and a first application configured to operate on the first OS;
a second endpoint of the manage network that implements a second OS, a second application configured to operate on the second OS, and an agent; and
an update device communicatively coupled to the repository device, the first endpoint, the second endpoint, and a second vendor device, wherein the update device is configured to:
receive from the second vendor device a first update configured modify the first application on the first endpoint and first metadata associated with the first update;
generate a first update package based on the first metadata, wherein the first update package includes a command and data sufficient to implement the first update on the first endpoint;
distribute the first update and the first update package to the first endpoint such that the first endpoint implements the first update according to the first update package to modify the first application;
access from the agent a product update list, wherein the product update list identifies the second application on the second endpoint that is in an unpatched state and repository information with which the second endpoint communicates to access a second update associated with the second application;
based on the repository information, access, from the repository device, the second update and second metadata associated with the second update;
generate a second update package based on the second metadata, wherein the second update package includes a command and data sufficient to implement the second update on the second endpoint; and
distribute the second update and the second update package, the distribution being configured such that the second endpoint locally implements the second update according to the second update package to modify the second application.

2. The system of claim 1, wherein:
the first OS includes a non-Linux-based OS; and
the second OS includes a Linux-based OS.

3. The system of claim 1, wherein:
the update device is configured to obtain outside metadata from an outside source; and
the second update package is generated based at least partially on the outside metadata.

4. The system of claim 3, wherein:
the outside source includes a common vulnerabilities and exposures (CVE) host site or a vulnerabilities management and prioritization site; and
the outside metadata includes one or more or a combination of a security or risk rating of the second update, an application affected by the second update, a patch type, a patch source, and a vulnerability severity.

5. The system of claim 1, wherein:
the update device is further configured to implement a policy related to the second endpoint;
the policy is configured to trigger an automated product update based on one or more values in the second metadata; and
the generation of the second update package and the distribution of the second update and the second update package is based on the policy.

6. The system of claim 1, wherein the update device is further configured to:
implement a policy related to the second endpoint;
determine that the second metadata includes insufficient information to assess severity of the second update;
determine whether the policy includes a default deployment configuration, the default deployment configuration triggers distribution of the second update in absence of the second metadata being indicative of information sufficient to assess severity of the second update; and
responsive to the policy including the default deployment configuration, trigger the generation and distribution of the second update.

7. The system of claim 1, wherein the update device is further configured to parse the second metadata to determine whether the second update includes a characteristic that triggers one or more automated update operations of the second application.

8. The system of claim 1, wherein:
the product update list is generated based on an inquiry communicated by the agent to the repository device and product information accessed by the agent at the second endpoint; and
the repository device includes an entity-specific repository device developed by an administrator of the managed network.

9. The system of claim 1, wherein the update device is configured to:
determine that a third endpoint includes the second OS and the second application; and
in response to the determination that the third endpoint includes the second OS and the second application, further distribute the second update and the second update package to the third endpoint.

10. The system of claim 1, wherein:
the repository device includes a first repository device;
the repository information is first repository information;
the product update list further identifies a third application on the second endpoint that is in an unpatched state and second repository information with which the second endpoint communicates to access a third update associated with the third application;
the system further comprises a second repository device for the third application on the second endpoint; and
the update device is further configured to:
based on the second repository information, access, from the second repository device, the third update and third metadata associated with the third update;
generate a third update package based on the third metadata, wherein the third update package includes a command and data sufficient to implement the third update on the second endpoint; and
distribute the third update and the third update package, the distribution being configured such that the second endpoint locally implements the third update according to the third update package to modify the third application.

11. A method of computer software update in a managed network that includes endpoints having heterogenous operating systems, the method comprising:
receiving from a second vendor device a first update configured modify a first application on a first endpoint and first metadata associated with the first update, wherein the first endpoint is included in a manage network and implements a first operating system (OS), and the first application is configured to operate on the first OS;
generating a first update package based on the first metadata, wherein the first update package includes a command and data sufficient to implement the first update on the first endpoint;
distributing the first update and the first update package to the first endpoint such that the first endpoint implements the first update according to the first update package to modify the first application;
accessing, from an agent of a second endpoint, a product update list, wherein:
the product update list identifies a second application on the second endpoint that is in an unpatched state and repository information of a repository device with which the second endpoint communicates to access a second update associated with the second application,
the second endpoint is included in the manage network and implements a second OS; and
the second application is configured to operate on the second OS;
based on the repository information, accessing, from a repository device, the second update and second metadata associated with the second update, wherein the repository device is communicatively coupled to a first vendor device that operates outside the managed network;
generating a second update package based on the second metadata, wherein the second update package includes a command and data sufficient to implement the second update on the second endpoint; and
distributing the second update and the second update package, the distribution being configured such that the second endpoint locally implements the second update according to the second update package to modify the second application.

12. The method of claim 11, wherein:
the first OS includes a non-Linux-based OS; and
the second OS includes a Linux-based OS.

13. The method of claim 11, further comprising obtaining outside metadata from an outside source, wherein the second update package is generated based at least partially on the outside metadata.

14. The method of claim 13, wherein:
the outside source includes a common vulnerabilities and exposures (CVE) host site or a vulnerabilities management and prioritization site; and
the outside metadata includes one or more or a combination of a security or risk rating of the second update, an application affected by the second update, a patch type, a patch source, and a vulnerability severity.

15. The method of claim 11, further comprising:
implementing a policy related to the second endpoint, wherein:
the policy is configured to trigger an automated product update based on one or more values in the second metadata; and
the generation of the second update package and the distribution of the second update and the second update package is based on the policy.

16. The method of claim 11, further comprising:
implementing a policy related to the second endpoint;
determining that the second metadata includes insufficient information to assess severity of the second update;
determining whether the policy includes a default deployment configuration, the default deployment configuration triggers distribution of the second update in absence of the second metadata being indicative of information sufficient to assess severity of the second update; and
responsive to the policy including the default deployment configuration, triggering the generation and the distribution of the second update.

17. The method of claim 11, further comprising parsing the second metadata to determine whether the second update includes a characteristic that triggers one or more automated update operations of the second application.

18. The method of claim 11, wherein the product update list is generated based on an inquiry communicated by the agent to the repository device and product information accessed by the agent at the second endpoint.

19. The method of claim 11, further comprising:
determining that a third endpoint includes the second OS and the second application; and
in response to the determination that the third endpoint includes the second OS and the second application, further distributing the second update and the second update package to the third endpoint.

20. The method of claim 11, wherein:
the repository device includes a first repository device;
the repository information is first repository information;
the product update list further identifies a third application on the second endpoint that is in an unpatched state and second repository information of a second repository with which the second endpoint communicates to access a third update associated with the third application; and
the method further comprises:
based on the second repository information, accessing, from a second repository device, the third update and third metadata associated with the third update;
generating a third update package based on the third metadata, wherein the third update package includes a command and data sufficient to implement the third update on the second endpoint; and
distributing the third update and the third update package, the distribution being configured such that the second endpoint locally implements the third update according to the third update package to modify the third application.
